(19) United States
(12) Patent Application Publication
(10) Pub. No.: US 2020/0018938 A1
(43) Pub. Date: Jan. 16, 2020

(54) Heat Concentrating Mirror

(71) Applicant: Donald Bennett Hilliard, Tucson, AZ (US)

(72) Inventor: Donald Bennett Hilliard, Tucson, AZ (US)

(21) Appl. No.: 16/510,975

(22) Filed: Jul. 14, 2019

Related U.S. Application Data
(60) Provisional application No. 62/764,070, filed on Jul. 14, 2018.

(51) Int. Cl. G02B 19/00

(52) U.S. Cl. CPC G02B 19/0019; G02B 19/0042; G02B 19/009

(57) ABSTRACT

The invention relates to optics for concentrating electromagnetic radiation; and, more specifically, concentrating optics for solar energy. The present invention discloses energy conversion apparatus; namely, those associated with apparatus for concentrating solar radiation, heat, and other electromagnetic radiation.

The present application is related to the following applications of the same inventor: PCT/US2017/068609 (Hilliard) filed Jan. 27, 2017; PCT/US2011/00966 (Hilliard) filed May 26, 2011; PCT/US2011/000050 (Hilliard) filed Jan. 11, 2011; U.S. patent application Ser. No. 15/544668 (Hilliard) filed Feb. 2, 2015; and, the various patent applications to which these are parent cases, all of which are included herein, in their entirety, by reference.

### FIELD OF THE INVENTION

The invention relates to optics for concentrating electromagnetic radiation; and, more specifically, concentrating optics for solar energy; in addition, the invention relates to associated materials systems utilized in such concentrating apparatus.

### BACKGROUND OF THE INVENTION

Several solutions have been proposed for high-concentration solar optics. Some of the more relevant prior art is recounted in above-listed patent applications.

### SUMMARY OF THE INVENTION

The present invention discloses energy conversion apparatus; namely, those associated with apparatus for concentrating solar radiation, heat, and other electromagnetic radiation. The present invention is seen as particularly useful in the area of specifically sized collectors, wherein the optic concentrator for concentrating to a central receiver is in the range of 0.5 to 2.5 meters diameter, although ranges outside of this range are contemplated and can also be advantageous under various circumstances.

In its first preferred embodiment, the disclosed invention is characterized as a paraboloid fresnel concentrator (PFC), wherein such PFC is necessarily a subset of compound conic concentrators (CCC) disclosed in previous patent applications by same author. In previous embodiments by same author, the CCC was embodied to as to alternatively provide either identical, or in some cases, non-identical irradiation of the solar receiver, wherein, in some embodiments, the lower frustums irradiated a subset of the receiver region irradiated by the upper frustums. The present invention may, once again, be embodied as any of a number of optical shapes (paraboloid, compound paraboloid, hyperboloid, etc.) In fact, the structures embodied may be found advantageous for externally-reflecting hyberboloid surfaces as utilized in “beam down” power towers.

The embodied non-imaging assembly for integration into the specified multi-frustum, PFC/CCC optic is also advantageous for providing a protective shield for the receiver during operation, which is suited both for protecting the receiver from the elements as well as limiting thermal emission due to its occluding and additional focusing characteristics.

A further advantage of the present invention is integration of non-imaging capability into a high-concentration form of a compound conical concentrator (CCC), and, more specifically, a paraboloid Fresnel concentrator (PFC).

Another objective of the present invention is to provide maximum combined utilization of diffuse radiation and direct normal radiation (DNI) for maximizing annual efficiency of a concentrating optic.

Another objective of the invention is to provide an integrated, light-weight assembly providing high-concentration capabilities of a dish concentrator, while simultaneously providing concentration of grazing horizontal irradiation and such forms of solar radiation that are propagating in directions other than those conventionally ascribed to direct normal irradiation (DNI).

A further objective of the present invention is to provide a non-imaging concentrator that provides focusing of both DNI and non-isotropic scattered radiation that is only marginally deviated from ideal DNI, so as to irradiate a single, short, vertical absorber located along the central optical axis of the concentrator, such that the over-all concentration level of the resulting optical system is increased over ideal DNI paraxial ray mapping.

Another objective of the present invention is to provide an interconnection structure whereby frustum rings are held in rigid alignment with each other, so as to form a high-strength, mechanically coupled assembly.

Yet another objective of the present invention is to provide a low-cost construction for highly precise, frame-free, high-concentration reflectors,

Another object of the present invention is provide a non-imaging, high-concentration optic that is highly flexible in its acceptance angle, through modification of a non-imaging radial element defining a radial optical cavity, located centrally within the optic's interior.

Another advantage of the present invention is a means of providing highly accurate and rigid conical frustums well-disposed for use in various forms of CCC and externally reflecting hyperbolic mirrors, which utilizes only several light-weight layers.

A further objective of the present invention is to provide reflector elements composed as conical frustum ring-shaped elements, which provided superior optical quality to the prior art usage of a layer of sheet metal, which is a accomplished through a laminate structure that incorporates a multitude of component layers that are each rigidly attached to adjacent component layers, thereby providing a set shape.

Yet another objective of the present invention is to provide means for high-concentration dish-type solar concentrators that protect the receiver element within a non-imaging assembly.

Another objective of the present invention is to provide a very thin cross-sectional thickness, conical frustum ring structure, which provides high rigidity and precision than practicable with utilizing thicker-gauge sheet metal pieces.

Another objective of the invention is to provide a low-emissivity absorber coating for high-temperature operation suitable for high concentration solar-thermal applications, wherein temperatures exceed those specified for current commercial solar-thermal absorber-receiver tubes, and where concentration levels render protective glass envelopes less practical.

Yet another objective of the invention is to provide a general used conduit structure for transporting high-temperature mediums for energy applications, wherein the medium is more corrosive than a vacuum.

### LIST OF FIGURES

FIG. 1(a) is a side section view of a compound conical concentrator (CCC), in form of paraboloid fresnel concentrator (PFC/CCC), of the prior art.

FIG. 1(b) is a perspective view of a compound conical concentrator (CCC), in form of paraboloid fresnel concentrator (PFC/CCC), of the prior art.

FIG. 1(c) is a side section view of an integrated PFC/CCC of the prior art.

FIG. 2(a) is a perspective view of an opposed pair of non-imaging radial optical elements (NIROE) in accordance with the first preferred embodiments.

FIG. 2(b) is a side sectional view of an opposed pair of NIROE

FIG. 2(c) is a top pan view of a NIROE.

FIG. 2(d) is a pan view of a optically non-imaging fin structure (ONIFS) in accordance with the first preferred embodiments.

FIG. 2(e) is a top pan view of an optic-reinforcement disk (ORD) in accordance with the first preferred embodiments.

FIG. 3(a) is a top pan view of an NIROE/ONIFS assembly in accordance with the first preferred embodiments.

FIG. 3(b) is a perspective view of the NIROE/ONIFS assembly in accordance with the first preferred embodiments.

FIG. 3(c) is a top pan view of an assembled paraboloid fresnel concentrator (PFC) of the first preferred embodiments, comprising an NIROE/ONIFS assembly with frustum reflector elements (80) attached, in accordance with the preferred embodiments.

FIG. 3(d) is a back-side pan view of an assembled paraboloid fresnel concentrator (PFC) of the first preferred embodiments, comprising an NIROE/ONIFS assembly with frustum elements and optic-reinforcement disk (ORD) attached, in accordance with the preferred embodiments.

FIG. 4(a) is a side-sectional view, taken along a plane containing the central axis (73) and axis (840), of an assembled paraboloid fresnel concentrator (PFC) of the first preferred embodiments of the invention.

FIG. 4(b) is a top view of an ORD retainer ring in accordance with the preferred embodiments.

FIG. 4(c) is a side-sectional view of alternative optical reflector profiles and associated optical cavities for the central non-imaging radial optical elements (NIROE) in various embodiments of the paraboloid fresnel concentrator (and, the more broadly embodied, paraboloid and non-paraboloid, compound conical concentrators) of the present invention.

FIG. 5(a) is a close-up break-away side-section view, by broken edge-line (889), of an assembled paraboloid fresnel concentrator (PFC) of the first preferred embodiments, taken along a plane containing the central axis (73) and axis (840), wherein is shown the central focal region of the non-imaging elements and receiver cavity, with receiver/tracker assembly attached, in accordance with the preferred embodiments.

FIG. 5(b) is the captioned view (872) of the edge-separation structure of the embodied PFC/CCC, pointing out more specific features in a side-sectional view, taken along a plane containing the central axis (73) and axis (840), wherein view is of the frustum edge-interface structure with adjacent fin, disposed at the adjoining edges of adjacent frustums of the embodied PFC/CCC, in accordance with the preferred embodiments.

FIG. 5(c) are pan views of alternatively configured PFC/CCC assemblies, showing alternative embodiments of the invention.

FIG. 6(a) is the captioned view of annular edge-interface region (872), taken along a plane containing the central axis (73) and axis (840), further pointing out a detailed sectional structure of the frustum edge-interface structure disposed at the adjoining edges of adjacent frustums of the embodied PFC/CCC, in accordance with the preferred embodiments.

FIG. 6(b) is a sectional view of a multi-layer frustum (MLSF) of the present invention, wherein the section is taken along a plane orthogonal to the central axis (73) and intersecting the frustum's mid-section, in a preferred embodiment.

FIG. 7(a) is a perspective view of a component multi-segment frustum layer composed of multiple segments (902), in accordance with the preferred embodiments.

FIG. 7(b) is a top pan view of a sheet-metal stock patterned with frustum segments, in accordance with the preferred embodiments.

FIG. 7(c) is a perspective view of a multi-layer, staggered frustum (MLSF) for integration into a CCC of the preferred embodiments.

FIG. 7(d) is a closed-caption view of an adhesive-pad grid pattern of the preferred embodiments.

FIG. 7(e) is a top pan view of the MLSF of the preferred embodiments.

FIG. 8(a) is a low-emissivity absorber coating for utilization on the high-temperature receiver surfaces in an alternative preferred embodiment.

FIG. 8(b) is a series of sectional end-views of solar receiver profiles having the low-emissivity coating in an alternative preferred embodiment.

FIG. 9(a) is a perspective view of components assembled to construct a high temperature conduit in an alternative preferred embodiment.

FIG. 9(b) is a sectional end-view of the conduit assembly in a vacuum enclosure in an alternative preferred embodiment.

FIG. 9(c) is a perspective view of a staggered conduit assembly in an alternative preferred embodiment.

FIG. 9(d) is a perspective view of two, joined, staggered conduit assemblies in an alternative preferred embodiment.

### DESCRIPTION OF THE PREFERRED EMBODIMENTS

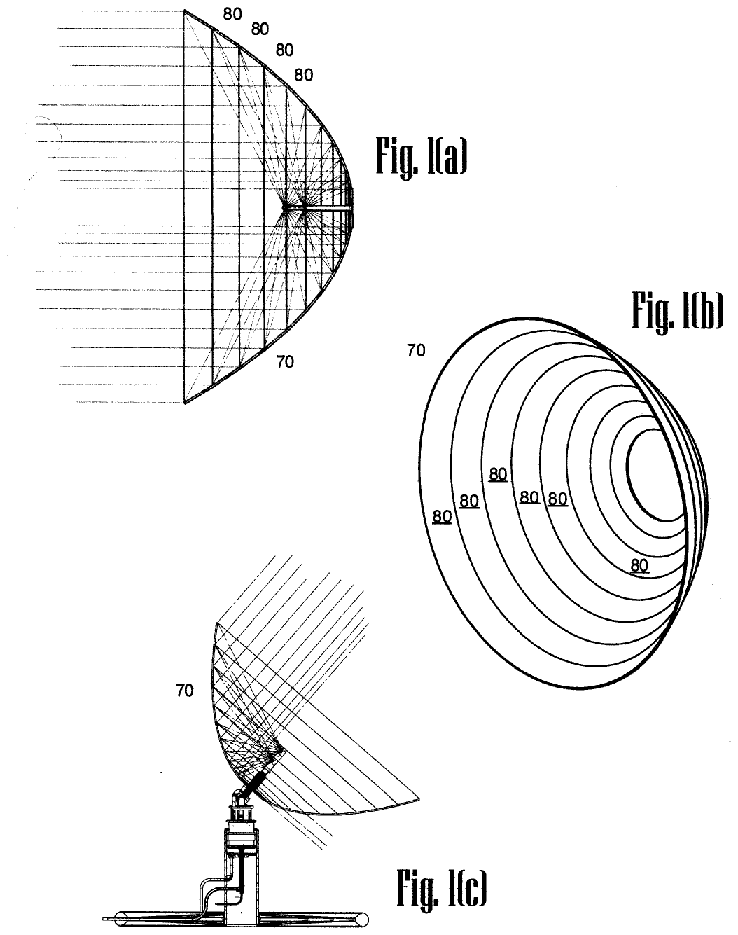

As disclosed in earlier-named patent applications by same author, the high-concentration solar concentrators of the present invention concern multi-frustum concentrators that incorporate a series reinforced frustum rings that are adjoined at their edges, in FIG. 1(a)-(b). These concentrators are typically incorporated in single or arrayed sets of concentrators that allow tracking of the sun for a multitude of applications including CPV, high-temperature solar-thermal, mid-temperature solar-thermal, thermochemical, photochemical, electrolyzing, and various other applications.

The concentrators are generally symmetric about central optical axis (73) delineating the central axis of the concentrator's symmetry, similar to the general dish-type optics, and preferably denoting the direction along which the solar radiation is directed. individual frustum elements (80) consistent with frustum elements identified by same numeric designation in early patent applications by same inventing author, are utilized herein, in addition to newly embodied versions.

In accordance with the first preferred embodiments, a optically non-imaging, concentrator-interior assembly having particular non-imaging attributes described herein, is disposed within a compound conical concentrator, providing both preferred light-concentrating characteristics, as well as integrating with the remaining concentrator structure so as to provide a mechanically robust concentrator structure.

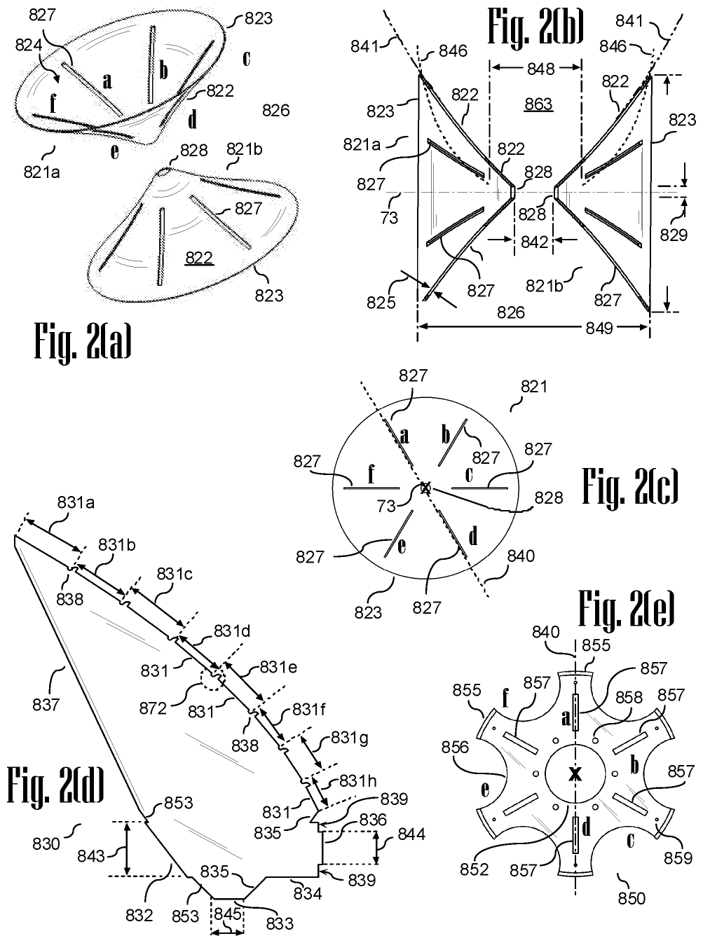

In particular, in FIGS. 2(a)-2(e) individual component structures are embodied, which together form a substantially rigid insert assembly about which the remaining concentrator is formed. A central structure in the present embodiments is referred to as a non-imaging radial optical element (NIROE), which is a, roughly, funnel-shaped optical element in the preferred embodiments.

Contrary to similarly formed non-imaging optics of the prior art, The optically reflecting surface of the NIROE is preferably formed as a surface of revolution (OSR) about the central axis (73), wherein, the external surface of the NIROE is the designated optically reflecting surface, and wherein the curve of the OSR is, contrary to non-imaging compound parabolic concentrator (CPC) optics of the prior art, preferably concave in the radially outward-facing, reflective surface (822) of the NIROE (821) , in FIG. 2(b).

The NIROE's optical surface-of-revolution (822) is a non-imaging, optical surface-of-revolution that is defined herein as conforming to a surface-of revolution corresponding to the solar-reflecting surface of the NIROE, wherein all OSR's embodied in the present invention are surfaces defined by rotating the embodied OSR section profile (dashed line curve in figure) about the central axis (73), which also corresponds to the optical axis of the preferred PFC/CCC in the preferred embodiments.

As a roughly funnel-shaped element, the NIROE (821) comprises a thin-walled structure conforming to a single surface-of-revolution about a central axis, such that the element extends between two opposing circular edges of the thin-walled feature, the two circular edges comprising a first circular inner-edge (828) defining a relatively small central orifice, the two circular edges comprising a second, circular outer-edge opposite the first circular inner-edge (828), the outer-edge (823) of the funnel-shaped NIROE forming the larger radius of the, roughly funnel-shaped, NIROE. In accordance with the thin-walled nature of the NIROE, the NIROE has, in addition to its solar-reflecting external surface, an opposing surface (824) of the NIROE, the opposing surface opposite the surface comprising the solar-reflective NIROE-OSR (822), in FIGS. 2(a)- 2(c).

The sectional thickness (825) of the (NIROE) thin material between OSR (822) and the opposing surface (824) of the NIROE is preferably between 0.001 and 0.250 inches, and more preferably between 0.030 and 0.100 inches, though other thickness are readily contemplated. The NIROE is preferably made of an aluminum alloy, though it may be made of any relatively rigid material, including from the group consisting of plastics, glasses, ceramics, and metals. Preferably the NIROE is formed by machine turning, though it may be readily formed by hydraulic deformation, powder metallurgy, molding, sintering, isotropic pressing, spinning, glass slumping, or any other appropriate fabrication method. It is also preferred that the reflective surface (822) of the NIROE be formed by PVD-type vacuum deposition, and that it comprise a protected silver multilayer in accordance with similar PVD/IBAD solar-reflecting multilayers well-known in the prior art of high-reliability solar reflectors.

In the first preferred embodiments, the NIROE is disposed as an axially-aligned pair (826) of opposed NIROE's, such that the space formed between the two opposed NIROE's becomes an effective non-imaging, annular cavity. Furthermore, the coupled pair (826) is disposed so as to couple together, and be mutually aligned by, radially positioned ONIFS, each NIROE having six radial fin slots (827) (labeled a,b,c,d, e, in the figures) in accordance with six ONIFS' of the exemplary preferred embodiments, wherein the slots are accordingly placed radially about the central orifice, in FIG. 2(c).

The diameter (829) of central orifice (828), as well as the effective cavity diameter formed by the adjacent focus edges (833) of the ONIF structures, is preferably slightly larger than the effective diameter of the solar-absorbing receiver of the receiver/tracking assembly to be accommodated. Since the embodied concentrator can readily provide effective concentration levels of 200-2000 suns, and the concentrator may be scaled to a variety of sizes, particularly in range of 0.5 to 2.0 meters (but clearly outside of this range as well) the range of receiver diameters will accordingly very greatly. In certain alternative embodiments, the orifice may be other than circular in shape to accommodate non-cylindrical absorbers, such as finned arrays, polygons, etc.

Another component of the preferred concentrator-interior assembly comprises a preferably fin-shaped optical element, herein referred to as the optically non-imaging fin structure (“ONIFS” or “ONIF structure”), though it will be understood by those skilled in the art that the shape of a “fin” is not necessary to the disclosed apparatus. The optically non-imaging fin structure (830), in FIG. 2(d), provides a thin plate-like profile that is reflective to electromagnetic radiation, and, preferably, specularly reflective to solar radiation, on either face (861) of the fin structure, which is preferably constructed of thin aluminum sheet of thickness preferably between 0.005 and 0.250 inches, and more preferably between 0.010 and 0.070 inches, though other thickness are readily contemplated.

The ONIF structure is preferably surfaced with a specularly smooth, solar reflective surface comprising a thin film stack of a protected silver or aluminum. Alternatively the specular surface may be provided by chemical polishing of the ONIF structure. In any case, it is preferred that the two opposing surfaces (861) of the thin-walled ONIF structure provide a specular-reflecting, solar-reflecting mirror surface, which is preferred for proper operating of the non-imaging characteristics of the embodied concentrator.

The embodied ONIF structures, in FIG. 2(d), also incorporates a faceted edge-surface comprising a series of linear facets (831), wherein it is preferable that each faceted surface be separated by a faceted-edge separation feature (838), the edge-features comprising a recess/tab combinations disposed for alignment of conical frustums (80) that are subsequently aligned and attached to the faceted edge-surfaces (831).

The embodied ONIFS also incorporates tab structures for insertion into and alignment with, the opposed pair (826) of NIROE's. An upper, NIROE-fastening, tab (832) of the ONIFS is disposed so as to insert into a radial slot (827) of the upper NIROE (821a).

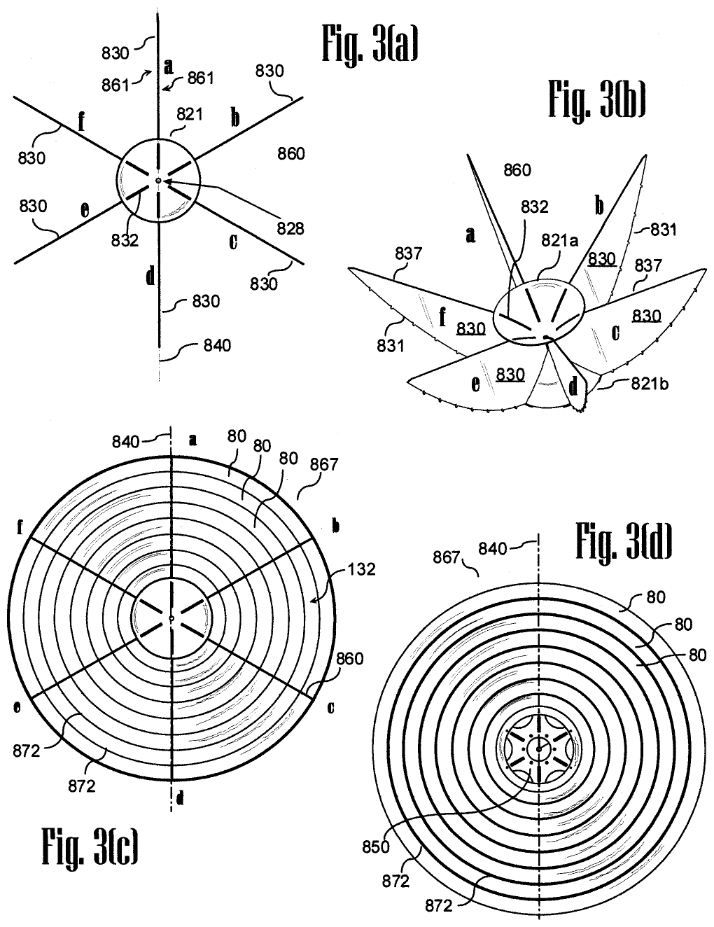

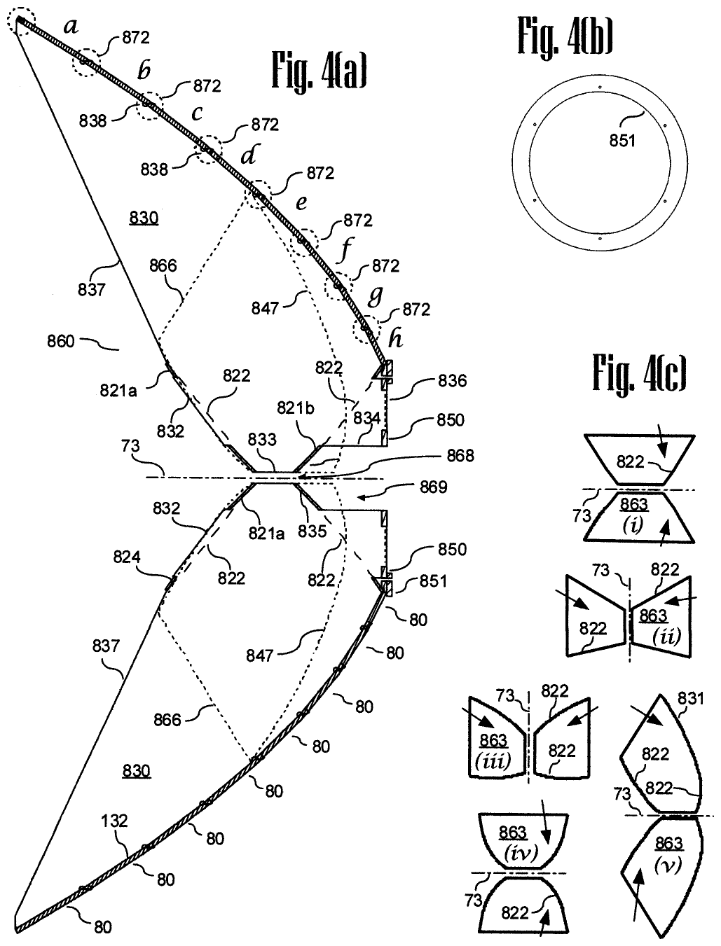

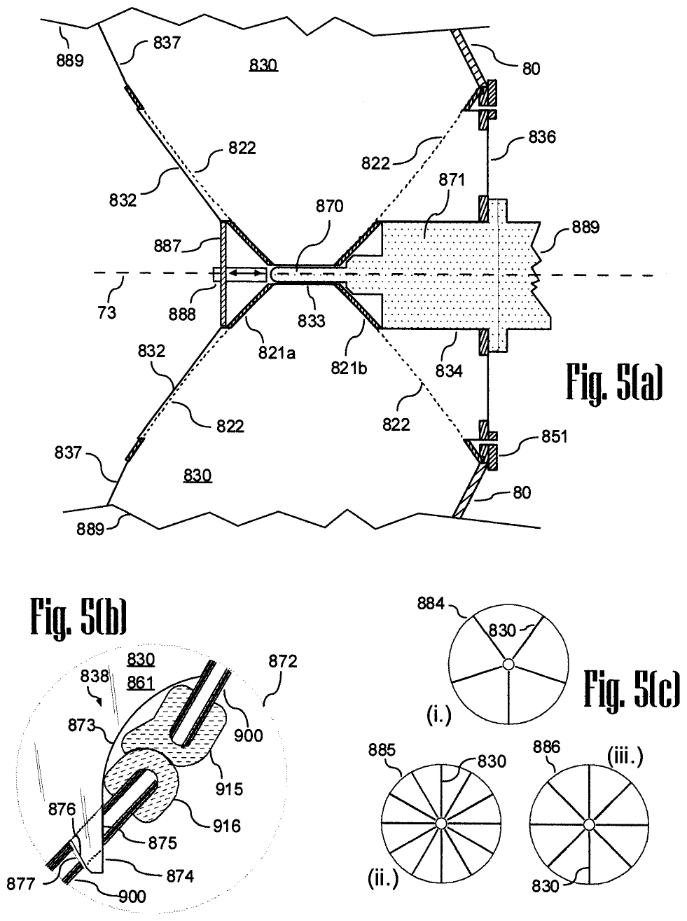

A NIROE-ORD interconnection tab (836) of each ONIFS is disposed so as to insert into a radial slot (857) of the optic-reinforcement disk (ORD) of the preferred embodiments, whereas the larger tab structure defined by lower NIROE-ORD interconnection tab (836), receiver-mount cavity edge (834), and ORD-alignment surfaces (839) on the ONIF structure provides an elongate structure that inserts into one of the aligned radial slots (827) of the lower NIROE (821b), in FIG. 4(a) and FIG. 5(a). , such that the NIROE-OSR (822) of the lower NIROE (821b) aligns to and presses against the identically curved alignment edge-surface (835) of the corresponding ONIFS. In this way, each of the six ONIF structures pointed out in relation to the exemplary embodiment is aligned to and snaps into place in conjunction to the accordingly aligned six radial slots in both elements of the NIROE pair (826), whereas the six lower NIROE-ORD tabs (836) of the aligned ONIFS may then be snapped into the identically aligned radial slots of the ORD, in FIGS. 3-5.

The ONIFS preferably incorporates an angled top ridge-edge feature (837), which may be seamed, hemmed, or otherwise reinforced, so as to provide additional strength to the thin-gauge metal of which the ONIFS is otherwise preferably constructed, thereby providing a higher rigidity/strength to the overall assembly of the embodied concentrator. In an alternative embodiment, various reinforcement structures may be formed on other edges, or elsewhere, on the ONIFS. An ONIFS faceted-edge separation feature (838) provides fastening and alignment means of the frustum rings (80) as is described in further detail.

In the preferred embodiments of a six-fin NIROE-ONIFS structure, the fins (labeled in clockwise sequence as a, b, c, d, e, and f), in FIG. 3(a)-3(b), are similarly installed, as a radial pattern, into the accordingly oriented slots of the NIROE pair (826), where sectioning planes are sectional plane (840) intersecting central axis and diametric slots “a” and “d”.

Whereas, the NIROE of the first preferred embodiments possesses a reflective surface-of-revolution (822) that is slightly curved so as to accommodate both solar etendue and a portion of non-normal, scattered solar radiation outside of the angular cone of conventional direct normal irradiation (DNI), this NIROE-OSR can possess other surface profiles, in FIG. 2(b), that provide greater acceptance angles and accordingly focus more scattered and horizontal irradiation outside of the DNI cone.

The spacing (842) between NIROE pair in the preferred embodiment, having the preferred NIROE-OSR, is similar to the receiver's absorbing length, as identified in the identified previous applications by author, wherein the receiver is positioned for absorption of all direct normal radiation in standard etendue of the sun (0.5 deg), wherein the presently embodied non-imaging insert assembly (860) will additionally concentrate irradiation to the absorber that is outside of ideal conditions so as to include more scattered radiation in a gaussian profile. In alternative embodiments incorporating NIROE-OSR more reminiscent of classical CPC figure, it will typically be advantageous to fashion the spacing (842) so as to accommodate greater scattering radiation in accordance with a wider acceptance angle.

The linear spacing (849) between parallel outer edges (823) of the corresponding aligned pair (826) of opposed and axially aligned NIROE elements, is shown in accordance with the first preferred embodiments, will preferably be a multiple of the receiver cavity length (842) and according receiver's absorber length, wherein this multiple is preferably in range of 3 to 10 times the receiver cavity length.

The length orthogonal to central axis (843) of upper fastening tab (832) and length (844) of lower fastening tab (836) in each ONIFS is preferably appropriate to allow snug fit into the corresponding slot lengths in the corresponding NIROE and ORD structures, respectively. The length (845) of the inner focus edge (845), which corresponds roughly to the preferred solar-absorbing portion of the solar receiver (870) as well as is preferably precisely equal to the spacing (842) of the NIROE pair (826), since the optical surfaces (822) of the corresponding NIROE pair preferably is conforming to and pressed against the adjacent alignment edge surfaces (835) (853) of the ONIF structures.

A reinforcement disk (850), herein referred to as the optic-reinforcement disk (ORD) is disposed so as to further reinforce and ensure inter-alignment of the PFC/CCC optic's adjacent structural components

The (ORD) disk is formed having a central orifice (852) that provides a preferred insertion port for the receiver/tracking assembly, where it will be understood that the receiver may be inserted and/or supported from either end of the receiver cavity formed by the ONIF's, whereas in the present preferred and exemplary embodiment, the receiver/tracking assembly is an integrated assembly that is fastened through being disposed within the embodied disk orifice.

The ORD incorporates an outer stepped edge(855), in FIG. 2(e) and FIG. 5(a), aligning to the lower NIROE assembly, which is preferably engages in a snap-in rigid alignment, wherein it may also be further reinforced with a resin or other form of organic adhesive, as may any other adjoining surfaces of the present invention. In the shown exemplary embodiment, six recessed surfaces allow venting and reduced weight in the embodied ORD, where recessed surfaces (856) are formed into the planar ORD, such recessed features separated by the disk-fin insertion slots (857) and outer stepped edges (855) of the OR, in FIG. 2(e).

The embodied ORD incorporates radial disk-fin insertion slots (857) that are oriented in number and dimensions so as to allow insertion of the lower ORD interconnection tab (836) of each of the six aligned ONIFS (830), in the exemplary embodiment. The ONIFS are further aligned to the ORD by means of the ORD-alignment surfaces (839) that accordingly become butted against the ORD (850), in FIG. 4(a) and FIG. 5(a).

An ORD inner fastener pattern (858) is formed in the ORD, and disposed to allow fastening to a flange of a receiver/mount assembly (871), which is preferably aligned to the embodied concentrator by both the inner fastening pattern and the receiver-mount cavity edges (834). An ORD outer fastener pattern (859) is formed in the ORD, and disposed to allow fastening to the retainer ring (851) (and optionally to the ONIFS)

A NIROE/ONIFS assembly (860), in FIG. 3(a)-(b), comprising a radial array of the ONIFS attached to a centrally disposed pair (826) of the opposing NIROE, such that the upper fastening tab (832) and lower fastening tab (836) of each ONIF is accordingly inserted into their respective aligned radial slots of the upper and lower NIROE in the opposed pair. In the first preferred embodiments, six symmetrically arranged ONIF are arranged symmetrically about and inserted into the six pairs of radial slots of the central NIROE pair (836). The NIROE/ONIFS assembly (860), is subsequently joined with the ORD (850) and frustum rings (80) in accordance with the preferred embodiments herein to form the concentrator structure, in FIGS. 3(c)-3(d)

An annular, radial optical cavity (863) is thus defined between the reflective surfaces of the NIROE pair. Specifically, the outer-facing surfaces of the coupled and aligned NIROE pair define an annular, non-imaging cavity that opens radially to the incoming radiation reflected from the interior of the embodied PFC/CCC concentrator, such that an increased angular cone of incoming light is focused onto a receiver disposed within the elongate receiver cavity formed along the central axis, between the opposed NIROE pair.

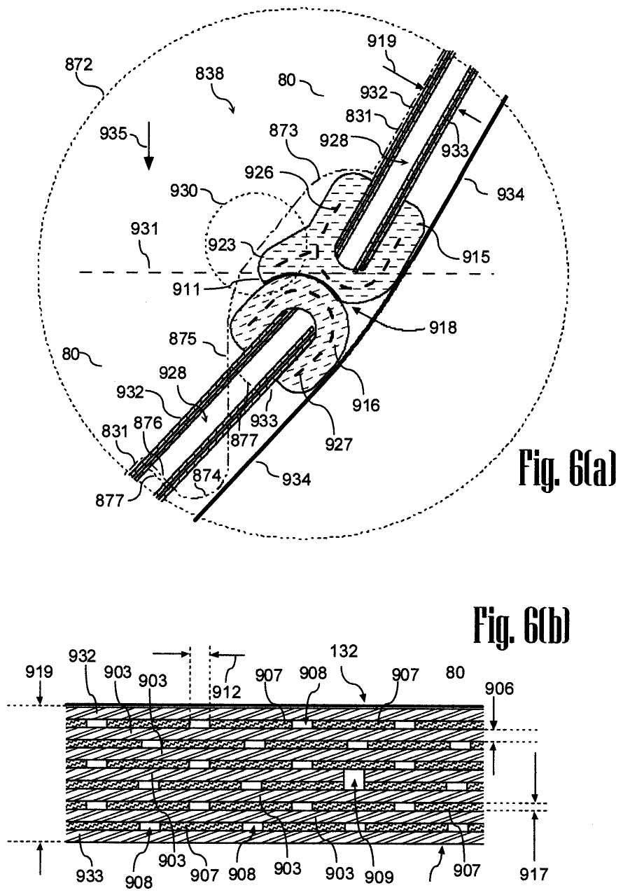

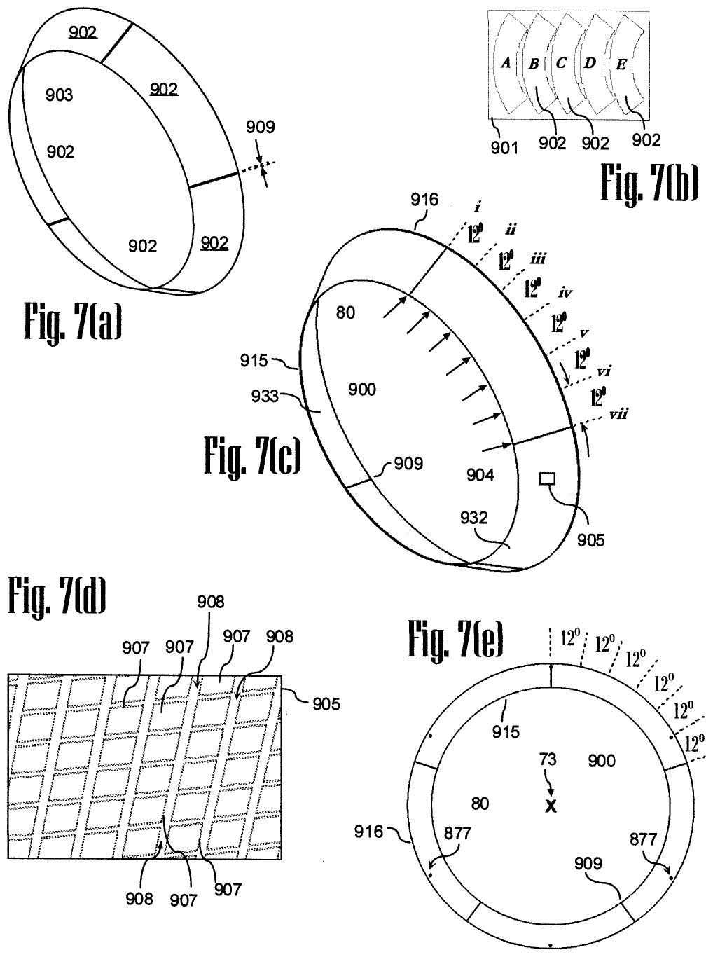

A parabolic fresnel concentrator (PFC) (867) of the present preferred embodiment does not necessarily conform to the preferred roughly paraboloid approximation, just as in previous embodiments, wherein the frustums do not direct mathematically normal solar radiation, which is perfectly parallel to the optical axis (73), to the same linear region of the absorber. As in embodiments of the CCC of previous applications by same applicant/inventor, it may be preferred that the lower frustums irradiate only a lower, and shorter, linear region of the absorber, wherein this shorter region is a lower portion of the absorber region irradiated by the uppermost frustum (e.g., see FIG. 1 in related PCT appln. PCT/US2011/00966 by same author). In another alternative embodiment, the lower frustums of the PFC/CCC are not consistent with a single roughly paraboloid (digitized) shape, but instead conform to a different curvature, such that the overall shape may be roughly represented a combination of parabolic curves, or a compound parabolic curve, similar to that of various CPC profiles of the prior art, except that the surface is rotated about a contrary axis of revolution, relative to those of the prior art, thus resulting in the paired radial optical elements (NIROE's) embodied herein. It will thus be understood by those skilled in the art that any of the embodiments disclosed in the present invention may be utilized in conjunction with the more broadly defined CCC structures disclosed in, previous listed, earlier applications by same author, wherein the CCC optic is similarly defined by a series of the conical frustum rings (80) interconnected in series to form an interior concentrator cavity. It will also be understood that all such structures, having no external frame-work, can alternatively be utilized to approximate very different cavity shapes formed as a series of conical frustum rings (with accordingly unique focal properties), such as compound paraboloid, hyperboloid, spherical, etc; and, that such the structures may alternatively be utilized having reflective external surfaces, such as those required for hyperboloid, convex optics utilized for “beam down” power towers. Whereas the present invention is preferably formed with a PFC/CCC in accordance with the preferred MLSF CCC embodied in conjunction with FIGS. 6-7 in the present invention, it is a preferred alternative embodiment to utilize the methods and structures pointed out in conjunction with patent applications by the same inventor; namely, PCT/US2017/068609 (Hilliard) filed Jan. 27, 2017; PCT/US2011/00966 (Hilliard) filed May 26, 2011; US patent application Ser. No. 15/544668 (Hilliard) filed Feb. 2, 2015, incorporated herein, in their entirety, by reference.

In the fully assembled PFC/CCC of the first preferred embodiments, in FIGS. 3(c)-(d) and FIG. 4(a), the frustums rings (80) are installed so as to rest against the faceted edge-surfaces of the ONIFS-NIROE assembly (860), with the exemplary embodiment including a series of eight frustums, labeled a-h, starting from the PFC/CCC top and working toward its base. In accordance with the previously embodied ONIFS, the separation structure (838), separating each successive faceted-edge surface (831), provides a precise registration surface for capturing the corresponding frustum, which is snapped into place in succession onto the insert assembly (860) from the bottom-side of the assembly. A receiver-mount cavity (869) tracker-receiver assembly cavity is accordingly formed by the ONIFS receiver-mount cavity edges (834), whereas PFC receiver cavity (868) is formed by focus edges (833) of the ONIFS as well as by the central orifice features (828) of the NIROE pair, between which the focus edges (833) are preferably trapped. ORD retainer ring (851), in FIG. 4(b), is utilized to provide clamping of the bottom-most frustum ring (80) as indicated by lettered frustum, h, thus additionally providing uniform compression to the frustum series.

In the first preferred embodiments, the preferred OSR sectional profile (841) defining optical surface-of-revolution of the preferred NIROE embodiment, is intermediate between a straight-walled cone and a surface profile that is outwardly concave in a manner similar to the interior of one side of a classic compound parabolic concentrator that is optimized for high acceptance angle. Slight curvature allows limited increase of acceptance angle while preferably not increasing the required length of the aborbing region defined within the receiver cavity of the embodied non-imaging assembly. In such a way the embodied NIROE-OSR can be marginally rendered outwardly concave to as to increase acceptance to non-ideal DNI (solid cone of 0.53 degrees). Preferably, the NIROE-OSR is, wherein rough sag across the surface is preferably, and generally configured as a CPC curve providing an acceptance angle of at least 5-degrees from each of the paraxial irradiation trajectories of the receiver surface by the previously described CCC under normal DNI, though other ranges of acceptance angle are readily accomplished, and will in fact, already provided within certain planes of paraxial propagation within the concentrator's interior. In this way, a limited increase in acceptance angle by the non-imaging assembly embodied herein will result in the same absorbing surface area of the solar receiver additionally receiving energy from marginally scattered DNI that is common in many atmospheric conditions.

The OSR profile is appropriate to increasing the effective acceptance angle of the embodied NIROE pair to accommodate solar disk radiation that is only marginally scattered, as is true of more Gaussian distributions under hazy conditions, rather than the more confined distributions of DNI witness on clear days. As such, there is no precisely optimum profile curve for the NIROE-OSR absent of a precise understanding of the specific mean annual distributions to be encountered in any given geography, as well as the precise load requirements (temperature, intensity etc), whereas accommodating such conditions, once understood, is readily accomplished through insertion of the modified solar profile into conventional commercial ray-tracing software.

Various profiles are demonstrated, in FIG. 4(c), wherein five separate OSR profiles for the NIROE pair (826) are shown as, as OSR profiles (822) and the resulting radial optical cavity (863) rotated about the central axis (73), with arrows shown intersecting the open end of the formed cavity, in same manner as the preferred cavity formed by the NIROE pair in previous figures. As is embodied, in FIG. 4(c), profiles i, ii, iii, iv, v, demonstrate various alternative embodiments of the OSR profile wherein the NIROE possess an optical surface that varies between the preferred outwardly concave profile of FIGS. 2-4, to a straight-walled cavity in FIG. 4(c)(ii). In the embodiments of i, iii, iv, and v, in FIG. 4(c), various outwardly concave profiles result in the NIROE pair forming a radial optical cavity that varies from a more tradition CPC cross-section—in iv, to asymmetric versions, in iii and v, as well as the asymmetric straight-walled version, in FIG. 4(c)(i). In the case of the asymmetric profiles, the bottom curve may be formed into the PFC/CCC itself, so that the surface is accordingly formed by the faceted surfaces (831) of the ONIFS, as indicated in FIG. 4(c)(v), as well as in FIG. 4(c)(i), and FIG. 4(c)(iii), wherein the bottom NIROE-OSR portion of these respective cavity profiles may simultaneously comprise a series of the frustum reflective surfaces, pressed against faceted surface-edges (831), that are accordingly those frustums comprising the central, innermost frustums of the embodied PFC/CCC, such that the separate element, bottom NIROE (821b) is not required as a in such latter alternative embodiments, as the central-most frustums provide the described annular cavity in conjunction with the upper NIROE (821a). This latter possibility is further demonstrated, in FIG. 4(a), wherein the ghost CPC-type profile indicates an alternative curve (847) of the ONIFS faceted surface, which is also the outline of the indicated asymmetric CPC-type radial cavity (847)(866). While the various alternative radial optical cavity profiles are described to indicate the various degrees of acceptance angles that may be accommodated, it will be appreciated that the PFC/CCC profiles will ideally be adjusted in design so as to have an optimized aspect ratio (and relative receiver height within the concentrator) to provide an optimum combination for concentrating both DNI and more scattered radiation. For example, the CCC optic in FIG. 4(a) would typically be made deeper with higher frustum angles to accommodate the ghost profile (847) into the ONIFS faceted-edge profile, so as to be roughly approximated by the resulting (no longer roughly paraboloid) CCC. Accordingly, in FIG. 2(b) the alternative OSR-CPC sectional profile (846) for NIROE pair in an alternative embodiment of an OSR having different non-imaging properties for wide acceptance-angle, wherein the OSR-CPC is disposed with a cross-sectional profile formed in accordance with a compound parabolic concentrator. As is embodied, in FIG. 2(b), the spacing (848) between NIROE pair in this alternative CPC-OSR embodiment will typically be larger (with corresponding longer absorber region of the inserted receiver tube), while potentially allowing a greater total flux to the receiver under more cloudy/hazy conditions.

In FIG. 5(a), broken view line (889) forms a broken view of the PFC/CCC so that the central receiver area is viewable in a close-up view. In the first preferred embodiment, a “hot-finger”—type solar receiver (870) is disposed within the receiver cavity (868) for receiving radiant energy from the sun, and accordingly, can be any of the receiver assemblies of the prior art, including any of the solar-thermal, photo-chemical, concentrated photovoltaic (CPV), thermochemical receivers of the prior art; particularly, those discussed in any of the previous patent applications be the present author.

Various forms of the receiver/tracking assembly (871) have been embodied in previous embodiments of the aforementioned applications by same author. In the present preferred embodiment, the receiver/tracking assembly comprises a single-ended receiver (referred to as a so-called “bayonet-type” receiver in recent literature) that is mounted to a flanged lower body that attaches to the concentrator base, in FIG. 5(a).

In certain embodiments, a top plate and shutter assembly (887) incorporating a tubular shutter (888) can be utilized in similar manner as disclosed in the previous applications by applicant, wherein a tubular shutter is translated along its axis to obstruct the optical paths propagating into the ONIFS-formed receiver cavity (868), in FIG. 5(a).

In various alternative embodiments, the PFC can be constructed with different numbers of ONIFS radially arranged about the interior of the PFC. For example, in FIG. 5(c), three alternative arrays are depicted by way of example, whereas it will be obvious that other arrangements may be readily fabricated.

While the exemplary embodiments are taught for the purposes of disclosure, it will be understood by those skilled in the art that numerous variations are readily derived that incorporate the same principles, functions, structures, and operational benefits. Accordingly, the disclosed NIROE-ONIFS assembly, in addition to incorporating a variety of OSR sectional profiles and curvatures, can also incorporate various angular separations between the ONIFS and accordingly varying numbers of ONIFS in the array. In FIG. 5(c), three different ONIFS arrays are described as further examples of the NIROE-ONIF assembly configuration; namely, in FIG. 5(c)(i) is a 5-fin array (884); in FIG. 5(c)(ii) is a 8-fin array (885); and, in FIG. 5(c)(iii) is a 12-fin array (886). It will be understood by those skilled in the art that such embodiments may incorporate any number of the embodied ONIFS in either even or odd numbers, thus allowing various degrees of non-imaging concentration for the GHI components of incoming solar radiation.

Localized edge-interface regions (872) within which the edge-structures of the adjoining adjacent frustums (80) and ONIFS of the first preferred embodiments, are interconnected are shown in conjunction with the closed-captions region (872) of frustum edge interface region of a PFC/CCC of the preferred embodiments, in FIG. 6(a). The edge-interface region contains the interfacing edge-rings in conjunction with the ONIFS faceted-edge separation feature (838), wherein the separation feature of the associated ONIFS is further detailed into its more specific physical features. Whereas FIG. 5(b) details the ONIF separation feature separating the faceted edge-surfaces (831) of the ONIF, as well as an associated upper-edge frustum slot (877), in the upper-edge region of each of the newly embodied frustum ring (900) , which is the preferred form of the frustum ring (80) in the present invention, the separation feature and slot are shown as a dashed line (though still detailed and pointed out) in FIG. 6(a), so as to allow clear view of the interface.

As in previous applications by same author, a frustum lower-edge termination structure (915), is preferably disposed along the bottom edge of the preferred MLSF frustum, as well as a frustum upper-edge termination structure (916) disposed along its upper edge, in FIG. 5(b) and FIG. 6(a), whereas, in the present invention, such edge-termination structures formed about the newly embodied frustum structure are embodied with accordingly distinct features.

In the preferred embodiment, each of the distinct frustum rings (80), or in newer frustum ring embodiment (900), are joined along the corresponding faceted edges (831) of the assembled NIROE/ONIFS assembly (860) through snapping into the corresponding tab structure, and forming a contact interface (918) between lower-edge termination ring (915) and upper edge termination ring (916) associated with the two adjacent frustums joined in a particular annular joining region (872). The lower-edge termination ring (915), as in previous patent applications by author, incorporates an annular region of bead overhang (930), wherein is incorporated an over-hang feature (911) (923) for effectively capturing the upper-edge termination ring of the adjacent frustum. The over-hang feature includes a portion (911) of the over-hanging lip residing below plane (931) orthogonal to central axis, in FIG. 6(a), wherein the central optical axis (73) is parallel to arrow (935) indicating normal solar radiation direction, wherein the orthogonal plane is defined as the plane intersecting the highest point intersecting the adjacent upper-edge termination ring (916) with which the lower-edge structure (915) of the above frustum is interfacing at the contact interface (918), as indicated in FIG. 6(a).

It is preferred, in the present preferred embodiments, that the edge-termination structures (915) (916) be composed of a polymeric compound providing limited pliability, such as silicone, acetal resins and molded plastics

In an alternative preferred embodiment, the edge-termination structures (915) (916) can also incorporate internal reinforcement fibers, or similar reinforcement means, imbedded within the edge termination structures, wherein, for example. a bottom-edge, U-shaped fiber reinforcement structure (926) is incorporated into the lower-edge termination ring (915); and, a top-edge, U-shaped fiber reinforcing structure (927) is incorporated into the lower-edge termination ring (916).

In the ONIFS faceted-edge separation feature (838), a recessed slot feature (873) of the ONIFS faceted-edge separation feature (838) provides clearance for interface region of the frustum lower-edge termination ring (915) and the upper-edge termination ring (916), in FIG. 5(b) and FIG. 6(a).

Within the ONIFS faceted-edge separation feature (838), an interlock tab (874) of the ONIFS faceted-edge separation feature (838) intersects a slot in the region of the frustum upper edge termination ring (916), whereby the frustums upper edge (edge closest to sun in tracking) aligns against, and is trapped by, the tab trapping edge (876) of the interlock tab, in FIG. 6(a).

Within the ONIFS faceted-edge separation feature (838), a vertical edge (875) of the ONIFS faceted-edge separation feature (838) is preferably an edge parallel to the direction of the optical axis (73), designated as an arrow (935) in the closed-caption, in FIG. 6(a), thereby allowing placement of the frustum rings over the interlock tabs (874). Accordingly, small upper-edge frustum slot features (877) are formed along the upper edge of the frustum, in FIG. 7(e) for insertion of the embodied tab (874) of the separation features.

The MLSF frustum sectional thickness (919) through the reflecting area (excluding edge termination rings) is potentially in the range of frustums disclosed in earlier applications; however, in the first preferred embodiments, utilizing the inventive frustum structure (900) presently disclosed, the cross-section thickness (919) is preferably only as thick as required to provide limited wind-loading capacity without the further support of the interlocking NIROE-ONIFS assembly. As such, the cross-sectional thickness (919) is preferably between 0.010 and 0.100 inches, and more preferably between 0.012 and 0.050 inches, though other thickness are readily contemplated, particularly in alternative embodiments outside of the most preferred diameter range of the concentrator's collecting-aperture of roughly 0.5 to 2.5 meters.

It is, in addition, preferred that a stretched architectural fabric (934) span the multitude of frustums along the disclosed concentrator structures externality, as previously disclosed by same inventor.

The frustum of the preferred embodiments, in being a multilayer structure, possesses a frustum interior space (928) as defined by interior (932) and external (933) frustum layers, the internal sheath layer (932) of frustum assembly having reflective outermost layer with reflective surface (132) facing the interior of the concentrator, in accordance with its solar reflective requirement.

In the embodied MLSF of the preferred embodiments, the interior space of the interior space (928) of the frustums (80), in FIG. 6(a), is preferably an extended series of staggered component layers, in FIG. 6(b), wherein a sectional structure is pointed out in conjunction with the overall MLSF construction provided further in FIGS. 7(a-e).

An adhesive pad gap width (912) separates adjacent adhesive pads, wherein the gap is preferably between 0.015-0.250 inches, and more preferably between 0.030-0.100 inches. The preferred MLSF layer-separation gap (917) separates adjacent component layers (903) of the MLSF, and this gap is uniformly maintained so as to be uniform about the MLSF, preferably by means of adhesive pads (907) separating the adjacent component layers (903). The layer-separation gap (917) between the adjacent component layers of the MLSF, and accordingly the thickness of the adhesive pads, is preferably a distance between 0.005 and 0.100 inches, and more preferably between 0.010 and 0.040 inches, though other thickness are readily contemplated.

The interconnecting adhesive pads (907) may contain fiber reinforcement, and in some cases the fiber may span across or around the overall frustum dimensions intersecting multiple pads. The pads are separately delineated so as to provide uniform stress/strain properties in the resulting concentrator structure, wherein an adhesive pad gap (908) accordingly is a visible gap that separates adjacent adhesive/resin pads, though there may be some limited contiguous resin/adhesive material interconnecting these separate regions of adhesive resin. The thickness (906) of the component layers (903) is a thickness range is preferably between 0.0005 and 0.0400 inches, and more preferably between 0.0005 and 0.0050 inches, though other thickness are readily contemplated.

In previous applications by same inventor, component conical frustum layers (903) are formed so as to provide cladding layers to clad specifically formed hollow-core and honeycomb-type core materials, where such cladding layers are assembled, in FIG. 7(a), as a frustum assembly made from multiple segments, wherein the frustum is composed of the multiple segments, each of which conform to the same surface-of-revolution, where various joining structures have been contemplated for joining the adjacent segments (902) of the cladding frustum.

Accordingly, a component multi-segment frustum layer (903) is composed of multiple segments (902) aligned substantially so that the interior surface of the multiple segments conform to one single conical surface-of-revolution. A similar component cladding frustum has been specified for the inner and external skin layers of frustums described in conjunction with preferred embodiments of the herein-listed previous patent applications by same author, wherein the individual embodied segments (902) and resulting cladding/component layer (903) will typically incorporate a layer of material that is comprised itself of different layers, which may include oxide protective layers, PVC (polyvinylchloride) factory coatings, laser-absorption coatings, etc. For example, as previously embodied, the segments utilized in the interior cladding of one individual conical frustum ring (80) will accordingly incorporate reflector multilayers providing the internal reflective surface (132), as provided in commercially produced sheet metal stock by such companies as Alanod, so as to provide the required solar concentrating properties. As previously embodied, the surface of the internal cladding frustum layer may also incorporate a reflector multilayer comprising any of the polymer-based reflector materials that are conventionally laminated onto such surfaces, including such products by ReflecTech/SkyFuel, 3M, etc.

In the present invention, a multi-layer staggered frustum (MLSF) (900), in FIGS. 6-7, allows a specific economical method for making, for some applications, lower-cost frustum rings (80) that are particularly preferred in conjunction with the inventive PFC/CCC assemblies disclosed in the first preferred embodiments of the present invention. More particularly, such MLSF rings are preferred for smaller concentrator embodiments wherein wind-loading is sufficiently lessened, or in more economical versions of larger embodiments.

As in previous embodiments (901)flat sheet stock/sheet metal rolled stock (901) is cut into the embodied segments (902), in FIG. 7(b), preferably by laser cutting, or optionally by stamping, water-jet, or any other appropriate method. In the present preferred embodiment, the rolled sheet stock may be of any useable thickness, but is most preferred in the range of foil stock, preferably in the range of 0.0005 to 0.01 inches in thickness; and, more preferably in the range of 0.0008 to 0.005 inches. It is found that when such thin stock is utilized in the configurations as disclosed in the preferred embodiments of staggered multilayer frustums, that the optical quality is found to allow high concentration levels, in excess of 200, and readily up to 2000 and above. Using single layer stock of the same thickness does not provide the same precision in retaining the ideal optical surface approaching that of a perfect conical surface.

In the exemplary embodiment, wherein the component layers (903) are each composed of five segments (902), in FIG. 7(a), an angular displacement about (73), for each successive component layer, of 12-degrees (12°) will result in a 7-component-layer MLSF wherein the component rings are uniformly staggered, in their angular position about the central axis. In this way, through symmetrically spaced angular spacings (904) of the embodied MLSF, the mechanical modulus of the MLSF is produced so as to be substantially uniform about the MLSF, such that optical figure of its reflecting surface is not deviated by a non-uniform internal stress.

The segments of the component layers (903) are preferably disposed so as to provide a single surface of revolution and accordingly do not overlap, but rather are separated by very small separation gaps. The segment-separation gap (909) defining the separation between two adjacent segments in the same component layer, is preferably such that, in the present preferred embodiments, two adjacent segments (902) in one component ring (903), in FIG. 6(a), do not overlap. Preferably there is minimum gap above that required to avoid such overlap in curing, wherein a gap (909) of 0.015-0.050 inches is typical sufficient.

Accordingly, in the exemplary embodiment, the MLSF is composed of seven, rotationally staggered, concentric, component conical frustum layers (903), which are laminated to one another so as to form the resulting MLSF. In particular, each successive component conical frustum layer is rotated about the central axis (73) with respect to the immediately adjacent component conical frustum layer, such that the centerline of the segment-separation gap (909) between segments of one component conical frustum layer is preferably displaced by a pre-set angle (904) with respect to the segment-separation gaps (909) of the immediately adjacent component layer (903), such that, preferably, the segment-separation gaps are uniformly distributed about the circumference of the inventive frustum structure, resulting in an according rotationally symmetric placement of the separation gaps present in the MLSF as a laminated composite of the total number of component layers used.

It is further preferred that the MLSF be formed as a whole prior to a preferred curing step following the assembly of the MLSF, such that the adhesive pads subsequently are cured into the embodied form of the conical frustum. In this way, by (1.) forming the segments; (2.), forming a component layer; (3.), forming adhesive pads onto the component layer; (4.), applying a subsequent component layer over the previous component layer at an angularly staggered, pre-determined angle with respect to the segment separation gap; (5.), repeating the steps (3.) and (4.) for a predetermined number n of iterations to create an MLSF of (n+1) component layers such that the resulting assembly of component layers provide a segment gap at each of a uniformly placed angle, equal to or smaller than the predetermined angle, uniformly about the periphery of the MLSF; and, (6.) curing the MLSF (preferably with heat-curing) so as to set the assembled MLSF into the desired conical shape.

Specifically, in FIG. 7(c) and FIG. 7(e), in the example wherein the MLSF is composed of seven component layers, a first interior layer, i, encircled by and laminated to second component layer, ii; component layer, ii, is encircled by and laminated to a third component ring, iii, and, so on, so that a series of seven rings designated as, i, ii, iii, iv, v, vi, vii, are concentrically laminated so as to form a single MLSF ring (903), wherein each successive layer is laminated to the previous layer by adhesive pads (907) formed onto the segments by patterned roller, or alternatively by ink-jet printing. A closed caption box (905) of sheath assembly in FIG. 7(c), is magnified, in FIG. 7(d) to indicate the grid pattern of adhesive pads outlined underneath the layer surface, in accordance with embodiments of FIG. 6(b).

The receiver (870), as referring to the general function of any solar energy-harvesting receiver (whether for photovoltaics, solar thermal, photochemical, photo-electrolyzing, thermo-chemical, desalination, supercritical-CO2, supercritical-steam, hybrid applications, etc) may incorporate any of the functions and/or applications disclosed in previous prior-listed patent applications by same author, and included herein in their entirety.

In the specific application of higher temperature solar-thermal applications (above 250 Celsius), it is generally advantageous that solid absorber coatings of the receiver incorporate means for limiting the emissivity of the absorber, thus reducing parasitic losses due to thermal emissions of the receiver. However, at temperatures above 450 Celsius, there is very limited availability of such low-emissivity absorbers. The present embodiment of a low-emissivity absorber is seen as particularly useful for high-temperature uses above 650 C, which typically do not benefit from protection to the ambient air by a vacuum enclosure.

While numerous solar-selective, multilayer absorber coating have been developed for use in the range of 100-400 Celsius, there remains an absence of commercially proven, low-emissivity absorbers for use at higher temperatures needed for many highly desirable high-temperature solar-thermal applications, including both DG and utility-scale installations. More particularly, at higher temperatures, particularly above 700 C, where glass vacuum barriers become increasingly impractical, and emissive losses become an increasingly dominant portion of parasitic losses, the need for air-stable, solar-selective coatings creates both a critical, and very different, materials challenge.

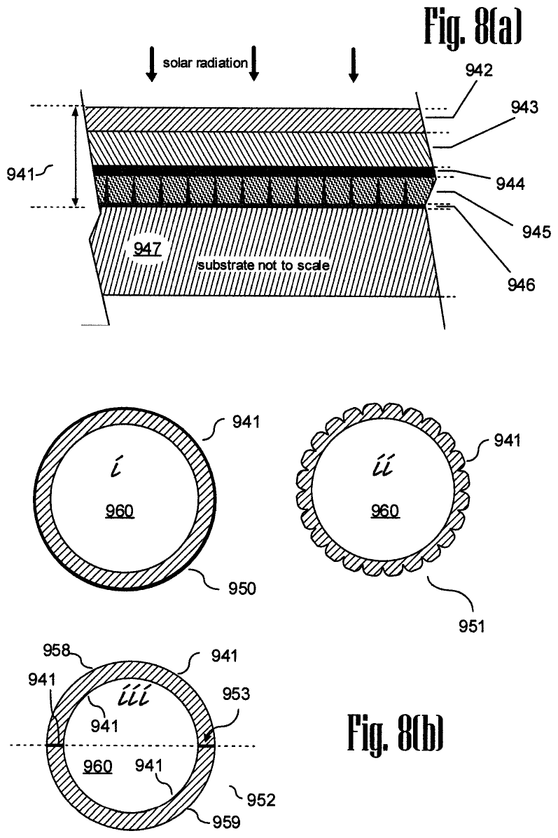

In the case that the receiver tube incorporates metallic substrates for the absorbing structure, a preferred embodiment of the absorber coating is embodied, in FIG. 8(a), which is particularly preferred for use in conjunction with high-Cr alloy substrates forming the HTM containing structure.

More particularly, and preferably, the embodied low-emissivity absorber coating (941) is disclosed as a component of a larger disclosed structure comprising a heat transfer tube or conduit, most preferably in the form of a solar receiver that is constructed of a particularly high Cr content, and in some cases almost completely chromium.

The high-temperature, low-emissivity coating (941) is, in the first preferred embodiment, formed over an article composed of a high-Cr-content (HCC) alloy (947), wherein the article is preferably a solar receiver disposed for receiving concentrated solar radiation from a solar concentrator, and wherein the underlying bulk metal forming the absorbing article of the receiver possesses an unusually high Cr content relative to the normal 300 and 400-series steels (autenite, ferritic, and martensite phases). The high-Cr alloy may be comprised of various precise compositions and phases, but is preferably containing between 22-95% chromium (Cr), and preferably and at least 3% iron (Fe). More preferably the Cr-content of the alloy is at least 24%. Commercial examples of such alloys with high Fe-content can be identified in proprietary compositions such as, for example, Crofer 22 APU (ThyssenKrupp), or FeCralloy (Goodfellow), Kanthal (Sandvik), ITM/CFY alloys (Plansee) (Alleghney-Ludlum). It is most preferred that the alloy is on relatively heavy Cr-content side of these various preferred alloys, where certain specialty alloys and powder metallurgy compositions, such as oxide-dispersed metals (CFY) produced by Plansee, are also highly preferred.

The alloy will often comprise multiple phases, wherein secondary phases may be dispersed within a body-centered cubic Cr phase. In some cases, oxide compositions are also dispersed in such high-Cr alloys, such as rare-earth oxides, namely Y2O3, CeO2, and the like. More preferably the high-Cr alloy contains at least 24% Cr to better enhance the graded layers added in the present invention.

In lower-cost alternatives that still some of the primary advantages of the present invention, certain alternative embodiments may use alternate compositions and phases as the bulk substrate, such as certain martensite and austenite steels. Alternatively the HCC material may be formed over an expansion matched ferrous steel or other alloy, wherein the high-Cr layer should be at least 500 nm thick, and more preferably in the range of 1 to 50 microns in thickness, upon which the preferred coating (941) is formed.

The high-chrome alloy substrate (947) is preferably utilized as the receiver structure, wherein it is preferred that the high-Cr-substrate (947) is coated with a lanthanum-manganite/lanthanum-manganite based material layer (945), preferably a lanthanum strontium manganite material of the ABO³ structure in a perovskite phase (945). The preferred ABO³ type perovskite phase is, most preferably, substantially mirrored in the absorber layer, as identified by sharing identifiable crystalline perovkite phases having an Lanthanum manganite composition.

The diffusion barrier layer (945) preferably transitioned into an observable (through microanalyis such as TEM-EELS) graded-composition layer (946) that is formed over the preferred HCC substrate material, wherein the composition of the graded composition layer is graded from bottom to top, and is distinguished in relation to the underlying high-Cr alloy by a transition from the nominal high-Cr alloy composition to a composition of increasing lanthanum and manganese content, such that the top surface of the graded composition layer is preferably, primarily comprised of a lanthanum manganite composition, preferably a lanthanum strontium manganite (LSM) composition underneath the refractory metal layer. In this way, the graded-composition layer is graded from top surfaces to underlying high-Cr alloy, between a substantially oxide composition to a composition having increased chromium content.

An IR-reflective metallic layer (944) is included in the present embodied solar selective coating, which provides both relatively high IR-reflectance to electromagnetic radiation above roughly 1.5 um in wavelength, in accordance with the necessity to provide relatively low emittance in this wavelength region; as well as synergy with the remaining materials layers utilized in resisting corrosion due to high-temperature service.

As temperatures approach 750 C, a substantial portion of the according black-body spectrum begins to increasingly overlap NIR portions of the (preferably utilized for energy) solar spectrum. Since, at these higher temperatures roughly 70% (?) of energy of the emitted black-body spectrum is between 1.5 um and 5.0 microns, it is imperative that maximum reflectivity be provided in this spectral region. Unfortunately, Pt has relatively poor NIR reflectance in the region of 1500 to 5000 nm. Rhodium-rich Pt solid solutions are introduced to substantially raise the reflectivity in this region while providing effective needed oxygen barrier properties.

The refractory metal layer (944) is formed over the preferred LSM-type layer (945), wherein the refractory layer is preferably a platinum-rhodium composition, preferably in the Rh-heavy side of the associated binary phase diagram, such that a solid solution is formed.

In some embodiments, the refractory metal layer (944) is preferable to incorporate pure rhodium, or alternatively pure platinum. Other solid solutions may also be used in certain alternative preferred embodiments, such as solid solution (as opposed to an intermetallic phase) of Rh—Ir, Os-Less preferred embodiments within the scope of the invention may incorporate relatively pure metals such as osmium, iridium, or platinum.

Alternative preferred embodiments can incorporate different refractory metal compositions in the refractory metal layer, including iridium, osmium, or rhenium. While Pt and Rh are preferred, Os, Ir, Os, Re, may also be used in pure form. In certain alternative embodiments where reduced wetting is preferred, small percentages (<10%) of gold may be incorporated). In some alternative embodiments, the IR-reflective metallic layer comprises CuNi solid solutions, preferably doped with Al2O3 are also capable to provide surprisingly good performance as a low-emittance coating while retaining anti-corrosion properties. Under less aggressive environments, it may also be found solid solutions of Ni—Cu (such as cupronickel) provide advantageous cost benefit, particularly alumina-dispersed Ni—Cu solid solutions. Still other alternative preferred embodiments may incorporate certain intermetallics, including TiAl phases.

A solar-absorbing layer (943) of the coating (941), is, in its first preferred embodiment, a lanthanum manganite layer having perovskite-type crystalline structure, such that the overall coating structure provides that the IR-reflective metallic layer (944) is sandwiched between two, lanthanum-manganite (or manganate) based perovskite compositions. Typical thickness of the preferably vacuum-deposited absorber will be less than 500 nm.

Thus, in the first preferred embodiment, the refractory metal, IR-reflecting layer is sandwiched between two similarly composed, complex oxide materials, most preferably a lanthanum manganite type material, and more preferably, a defective perovskite phase of the lanthanum strontium manganite (LSM/LSMO) group of materials, wherein Cr-doping is preferred for high absorption, whereas any of the dopant materials utilized in the prior art of this perovskite material may be incorporated.

In an alternative embodiment, the absorber layer is composed primarily of a Group 4a metal oxide, namely, a zirconia, titania, or ceria layers. As has been described in previous solar absorber layers of the prior art, these layers can be formed with numerous inclusions in the nanophase scale, such as platinum, gold, chromium, carbon, molybdenum, and titanium. Such Group 4a oxide absorbers can also be fabricated to contain certain percentages of nitrided, or oxynitride, compositions.

In the alternative embodiment wherein the absorber film section (943) comprises a Me:ZrO2 or Me:TiO2 composition, or combinations of such Group IVa elements, wherein Me is a non-Group-IVa metal, and a refractory metal providing precipitation into nano-phase precipitates observable by high resolution Transmission Electron Microscopy (TEM), it is preferable that Me is a metallic substance including either a pure metal such as Pt, Os, Ir, Os, Mo, Rh, Cr, or any other refractory acting metal; or alternatively it may be a metallic-acting metal-nitride or metalloid, such as a TiNC, carbide, silicide, boride, carbon or silicon. LaZrO compositions, including La2Zr2O7 may also be utilized as the absorber in certain alternative embodiments with similar precipitate metal inclusions as aforementioned in the absorber materials.

In an alternative preferred embodiment, the absorber layer is graded in its composition, or contains two (or more) separate absorber layers, wherein the preferred double absorber layer pair comprises a first layer, adjacent the refractory metal, comprising the lanthanum-manganate perovskite. The second layer, formed over the LSM-type perovskite, preferably comprises a phase stabilized zirconia containing nanophase platinum precipitates, providing the general high/low-precipitate, dual-layer absorber, absorber configuration well-known in the prior art of thin film solar-absorber layers. Similarly, such variation of the Me-precipitate content may be formed as a graded composition, gradually increasing toward the substrate across a typically sub-micron film thickness, as is commonly practiced in the solar-selective absorber art.

The uppermost layer of the disclosed multilayer coating (941) preferably comprises a phase-stable, CTE-matched low-index AR layer. In the past, the anti-reflecting layer was most often comprising a silicon dioxide material (silica) for providing a relatively low refractive index of appropriate transmissivity. While silica may be utilized in the present invention as a less preferred embodiment, it is found to be non-preferred for higher-temperature application.

More generally, an anti-reflective (AR) coating section (942) formed over the absorber layer (943) may be one of any appropriate AR coatings discussed in the prior art for such low-emissivity absorber coating applications, including silica, alumina, complex oxides and other materials that provide a layer corresponding to an effective refractive index lower than n=1.6, appropriate for the low index layer of an according AR coating for matching admittances for the range of absorber coatings complex indices. As such, the AR coating section may also include any of the various “V-coat”, 3-layer and 4-layer coatings previously discussed for these applications in the prior art. Though, in the preferred coating incorporated in the present embodiment, it is preferred that an AlxMg-based oxyfluoride antireflection coatings is utilized as the low-index layer. In the case of a single-layer AR coating the thickness of the Al/Mg-based oxyfluoride layer will typically be in the range 100-200 nm depending upon the precise indices utilized.

In the preferred embodiment wherein the AR coating comprises a dense AlMgₓOF layer, wherein the O-F ratio is preferably in the range between 25% to 100% fluorine, and more preferably between 25% to 75% fluorine, wherein it is preferred that the resulting material simultaneously provides a refractive index between 1.38 and 1.6, and preferably less than 1.55, whereas the coefficient of expansion is maintained in the region of 8 to 14 ppm/C. In certain embodiments it may be preferable to provide a graded index layer wherein the relative fluorine percentage of O-F composition ratio is increased gradually to the substrate surface.

In the first preferred embodiment, the top layer of the inventive absorber structure is composed of an oxyfluoride material, primarily a metal oxyfluoride selected from the group consisting of aluminum, or alternatively a mixture including both aluminum and magnesium. Alternatively the AR coating may comprise any of the materials utilized in low-emittance solar absorber coatings of the prior art, including V-coats, 4-layer designs, and other multilayer antireflection coatings well-known in the prior art, wherein the antireflective segment is formed over the absorber section, and will comprise at least one low-index layer with real refractive index in the range of about 1.5 or lower.

For example, if enhanced AR properties are desired in a four-layer AR, it is preferred that the AR coating be combined with a yttria-stabilized, or other dopant-stabilized, zirconia as the high-index layer, wherein the phase-stabilized ZrO2 layer may alternatively contain other stabilizing components such as a scandium, magnesium, or other known phase stabilizing metal, to produce a phase-stable high-index layer. An intermediate-index layer of aluminum oxide is preferred for designs incorporating an intermediate index material.

All layers of the disclosed low-emissivity absorber coating are preferably formed by energetic plasma deposition, such as through reactive magnetron sputtering, as is commonly practiced in the art of low-emissivity coatings.

In conjunction with the preferred application of solar-thermal applications, the embodied low-emissivity absorber coating (or, solar-selective coating) is particularly utilized, in its preferred embodiment, as a coating provided the preferred characteristics by virtue of being formed as a specific materials system including a specific type of metal alloy as the underlying substrate.

The preferred high-Cr-alloy substrates are utilized as a solar receiver's absorbing body in the preferred solar thermal applications that include concentration of solar energy onto the solar receiver's absorbing region. In particular, in FIG. 8(b), the HTM-carrying receiver tubes may have several different physical attributes. For example, the high-Cr-alloy may form a standard cylindrical receiver tube (950), in FIG. 8(b)(i).

One alternative embodiment is to utilize a scribed, corrugated, or spirally fluted tube cross-section for the absorbing receiver tube (951), in FIG. 8(b)(ii), wherein the external surface relief is preferably formed into the tube exterior surface prior to coating, thus resulting in both stress relief as well as enhanced absorption. In a further alternative embodiment, a split/bifurcated tube (952) is embodied having interfaces between two half-cylinder sections, first bifurcated cylinder half (958) and second bifurcated cylinder half (959), mated at flat mating-surface features (953) wherein such flat bifurcation surface is similarly coated on its interior and sealing surfaces with the low-emissivity coating (941) before sealing, in FIG. 8(b)(iii), thus providing highly inert interior surfaces resistant to HTM-based corrosion. In such latter embodiments, it is preferred that the flat mating surfaces (953) be ground and polished to less than 1 micrometer surface deviation from flatness, prior to coating with the multilayer.

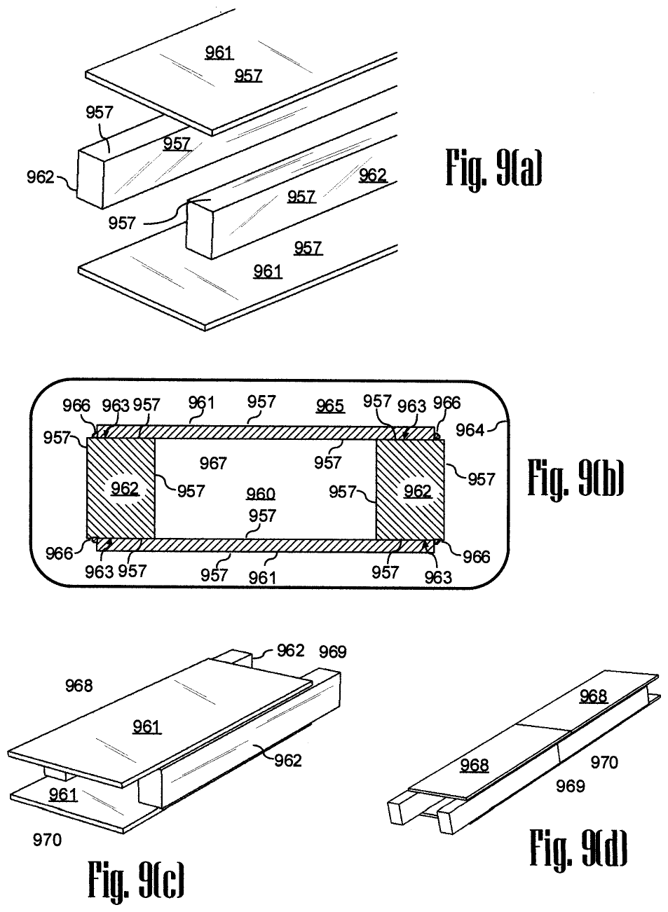

The disclosed coating substrate combination is also compatible with various high temperature fluids within specific embodiments, wherein the absorber and AR coating layers of the coating are preferably absent, and the coating is terminated by the previously embodied refractory metal reflectors, preferably Pt/Rh solid solution, or alternatively .

Whereas, the bifurcated embodiment (952) in FIG. 8(b) may be utilized with the low-emissivity protective coating to be used on high-Cr alloys forming conduit for transporting high-temperature (>250 C) fluids as heat transfer fluid or heat transfer medium of the present invention, in any generic conduit, fluid transport function, it is preferred that a general conduit structure provide more highly controlled interface structures than are practical on cylindrical substrates. Accordingly another alternative embodiment, in FIG. 9(a)-(d) provides increased quality in the interface control than is typically possible in cylindrical interiors.

In the current alternative embodiment, a conduit assembly (967) and associated structure is embodied, which utilizes the low-emissivity coating in certain specific embodiments thereof. A conduit assembly of the present embodiment is specifically advantageous for use with corrosive fluids and other media used as heat transfer media (HTM) in conjunction with high temperature applications, whether in the preferred embodiment of a high-temperature solar-thermal application, or in alternative embodiments such as high-temperature GENIV nuclear reactors or other such applications wherein in molten salts and similar media suitable for high-temperature HTM's are transported through piping, tubing, and the like.

In the preferred embodiment, the embodied conduit is constructed of at least three primary pieces; namely, two plate-like articles (961) that form opposing sides of the embodied conduit, and, opposing interconnect blocks (962), which are preferably separate, though may alternatively be connected by narrow interconnect features residing within their mutual planar aspects, in an intermediate space forming the resulting conduit's flow-space.

The preferred components of which the conduit is formed, in FIG. 9(a), are thus two conduit plates (961) and two conduit interconnect blocks (962). The two interconnection blocks are elongate pieces of the preferred high-Cr alloy, formed in the generally rectangular shape, whereas the conduit plates will also have an elongate aspect with rectangular cross-sectional shape, in FIG. 9(b), such that the opposed conduit plates bridge and cover the interconnect blocks so as to form the embodied mating interfaces (963), and thereby forming the resulting conduit's flow-space. It is then preferred that these mated components are held in this compressed sandwich form by means of hermetic seam-welds (966) along the formed exterior intersection, wherein seam welds (966) are formed preferably by TIG welding, or alternatively an appropriate MIG welding are preferred seam weld means.

The simple geometry shown allows for crucial advantage of high-quality polishing of the mating surfaces, as well as the surfaces forming the heat transfer medium flow-space (960). The surfaces forming the mating surfaces of the embodied conduit are preferably ground, and more preferably, subsequently, polished, to high tolerances, such that these according surfaces are extremely flat, with surface RMS roughness less than 5 microns, and with deviation of the surface from flatness also less than 5 micrometers. Within 90% of the mating area, it is more preferred that the flatness is higher, such that convexity or concavity does not result in an according sag of greater than 1 micrometers across width (short dimension) of these mating regions.

Preferably all sides of the components (chamfered as appropriate) are coated with the embodied low-emissivity coating in its non-absorbing alternative embodiment, wherein the absorber film section (943), and anti-reflective coating section (942), such that the mating interface comprises both surfaces to be mated together being terminated by the resulting coating with IR-reflective metallic layer (944) capping the preferably polished surfaces of the blocks and plates as the top-most layer, thus forming a refractory-metal-capped, low-emissivity layer (957).

Accordingly, in the present embodiment of HTM conduit, the multilayer (957) that is formed over the preferred high-Cr-alloy can be identical to the embodied low-emissivity solar absorber, in FIG. 8(a), except that the absorber film section (943), and anti-reflective coating section (942) are preferably not present in the case of such non-absorbing application. It is also preferred that the IR-reflective metallic layer (944) be doped by between 1-15%, and preferably around 5% gold during deposition, so as to form a non-wetting surface in the interface mating regions (963).

Thus, an HTM conduit is utilizing a specifically terminated surfaces allows high-reliability transport of corrosive liquids and vapors utilized in conjunction with high-temperature solar-thermal applications. Reliable performance is obtained through a method of (A.) fabricating substantially rectilinear components from the High-Cr alloys described earlier, (B.) surfacing the components by grinding flat and optically finishing surfaces of the components so as to provide flatness of contacting regions of component surfaces to within less than 2 microns of variation within the regions within the inner 80% of the contacting surface, (C.) depositing a first complex oxide coating onto the contacting surfaces of the components, (D.) depositing a low-emissivity refractory metal onto the complex lanthanum oxide compound, (E.) contacting the surfaces of the components so as to form the rectangular conduit.

It is preferred that the resulting conduit is utilized in conjunction with an evacuated conduit (964) such that both convective and radiative heat losses are minimized, due to the conduit being substantially encapsulated by the accorded by the evacuated shield space (965) formed by the evacuated conduit (964).

While the embodied conduit may be interconnected by various plumbing structures attached by welding or diffusion bonding to its ends, certain approaches are embodied that further utilize the approach already taken, which is to limit exposure to polished and coated surfaces in the manner just described. Accordingly, in an embodiment the conduit plates (961) and conduit interconnect blocks (962) are mated and sealed in a staggered arrangement, in FIG. 9(c) and FIG. 9(c), providing an staggered conduit assembly (968) with effective male end (969) and female end (970) that can be accordingly mated with similar precision surface-mating of the coated surfaces.

The preceding solar concentrator structures of the preferred embodiments are seen as particularly well-suited as light-weight apparatus suitable for deployment on roof-top installations, either as singly tracked units, or in coupled arrays of multiple PFC/CCC units, each tracking the sun through interconnected mechanical means.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. The terms used in the following claims should not be construed to limit the invention to the specific embodiments disclosed in the specification and the claims.

What is claimed:

1. A heat concentrating mirror, comprising:
a.) a series of rings, the rings in the form of conical frusta, the frusta having solar-reflective interior surfaces, the surface aligned so as to form a concentrator cavity space;
b.) a first non-imaging insert assembly, the non-imaging insert assembly aligned so as to occupy the cavity space formed by the series of conical frusta, the non-imaging assembly comprising a radial array of fins optically separating the concentrator cavity space into at least five separate cavity spaces; and,
c.) a second non-imaging insert assembly, the second non-imaging insert assembly comprising an opposed pair of radial, funnel-shaped elements, radial elements each having an outward-facing surface, the outward-facing surface providing at least 80% solar-weighted reflectance to the visible solar spectrum, the pair of radial elements separated by and partially defining a central cavity space disposed centrally along the central optical axis, the central cavity space adapted to the collection of solar energy by a solar receiver disposed within the central cavity space.

2. A process for producing a heat concentrating mirror, including the steps:
a.) a series of rings, each ring in the form of conical frusta, the frusta having solar-reflective interior surfaces, the surface aligned so as to form a concentrator cavity space, the rings formed from a multitude of alternating layers of substantially solid material layers, the solid material layers forming edges located in staggered relation to one another.

3. A heat concentrating mirror, comprising:
a.) a series of rings, each ring in the form of conical sections, the sections having solar-reflective interior surfaces, the surface aligned so as to form a concentrator cavity space; and
b.) a curved element within the cavity space, the curved element concentrating electromagnetic radiation toward a central receiver element, such that the curved element concentrates the electromagnetic radiation by means of non-imaging concentration.
